(19) United States
(12) Patent Application Publication
(10) Pub. No.: US 2010/0292411 A1
(43) Pub. Date: Nov. 18, 2010

(54) MODIFIED RUBBER AND MANUFACTURING METHOD FOR THE SAME

(76) Inventors: Katsuhiko Nakajima, Aichi-ken (JP); Masatoshi Matsuda, Aichi-ken (JP); Yoshimasa Yamamoto, Niigata-ken (JP); Seiichi Kawahara, Niigata-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/863,999

(22) PCT Filed: Jan. 16, 2009
(86) PCT No.: PCT/JP2009/050567

§ 371 Date: Jul. 22, 2010

(30) Foreign Application Priority Data
Jan. 23, 2008 (JP) 2008-012276

(51) Int. Cl. C08F 224/00; C08F 8/08

(52) U.S. Cl. 525/385; 525/55

(57) ABSTRACT

Double bonds, which are included in the respective isoprene units of natural rubber, are converted into epoxy groups, and are subsequently converted into hydroxyl groups by hydrolyzing the resulting epoxy groups. Since it is possible to introduce hydroxyl groups into all of the double bonds securely, and moreover since it is possible to introduce many hydroxyl groups into them, it is possible to utilize the setting for films for food packaging that are good in terms of gas non-permeability.

### TECHNICAL FIELD

The present invention relates to a modified rubber, which serves as a functional polymeric material that is useful for films for food packaging, the inner liners of tires, and the like; and to a manufacturing method for the same.

### BACKGROUND ART

In current industries, a variety of functional organic materials, which are produced using raw materials that stem from fossil fuels such as petroleum, have been used. For example, ethylene-vinyl alcohol copolymer, one of the functional polymeric materials, has been employed in such an application as food packaging, such as bottles for mayonnaise, while making use of its remarkably low gas permeability. This ethylene-vinyl alcohol copolymer is produced in the following manner: ethylene and vinyl acetate, which stem from fossil fuels, are copolymerized radically; and the resulting ester parts are thereafter hydrolyzed to introduce hydroxyl groups.

In films for food packaging, the non-permeability to oxygen is an important property. When grasping the oxygen permeability coefficient of ethylene-vinyl alcohol copolymer from the viewpoint of polar group, it has been understood that the more hydroxyl groups one has the smaller oxygen permeation degree it exhibits. On the other hand, when hydroxyl groups become too much like 50% or more, the gas non-permeability has lowered under high humidity, or its applications have limited because of being crystalline.

Moreover, in recent years, a premium has been put on the problem about the depletion of fossil fuels; in addition to being forced to employ the raw materials that stem from fossil fuels, carrying out the deacetylation by means of hydrolyzing the ester parts is disadvantageous from the viewpoint of atom economy. Therefore, in these years, it has been desired to use environment-conscious organic materials that stem from natural resources.

Hence, the inventors of the present application focused their attention on natural rubbers, one of natural polymeric materials, as substitutes for the ethylene-vinyl alcohol copolymer, and the like.

As a technique for modifying/degenerating natural rubber, a method in which a natural rubber is subjected to a deproteinization treatment and is then epoxidized furthermore is set forth in Japanese Patent No. 3,294,903. A modified natural rubber being obtained by means of this method does not cause allergy because it does not have any protein, and is good in terms of properties, such as oil resistance and anti-gas permeableness, while keeping maintaining strength. Therefore, it is possible to employ it suitably for applications, such as hoses and the inner liners of tires.

Moreover, a rubber composition is described in Japanese Unexamined Patent Publication (KOKAI) Gazette No. 57-125,230, rubber composition which is completed by compounding a liquid rubber, which has a hydroxyl group at one of the opposite ends of the molecular and has epoxy groups inside the molecule, with a solid rubber; and not losing the inherent elasticity of the solid rubber, and having good forming workability are set forth therein.

Patent Literature No. 1: Japanese Patent No. 3,294,903; and

Patent Literature No. 2: Japanese Unexamined Patent Publication (KOKAI) Gazette No. 57-125,230

### DISCLOSURE OF THE INVENTION

### Assignment to be Solved by the Invention

The present invention is one which has been done in view of the aforementioned circumstances, and it is an assignment to be solved to provide a functional polymeric material, which is good in terms of gas non-permeability, using natural rubber as the raw material.

### Means for Solving the Assignment

A characteristic of a modified rubber according to the present invention which solves the aforementioned assignment lies in that:

it is prepared from a rubber raw material in which polyisoprene makes a major component; and

it is completed by converting at least a part of double bonds that are included in respective isoprene units into hydroxyl groups.

It is preferable that all of the double bonds that are included in the rubber raw material can be converted into hydroxyl groups and tetrahydrofuran rings (hereinafter being referred to as “furan rings”); and it is desirable that all of the double bonds that are included in the rubber raw material can be converted into hydroxyl groups. Moreover, it is allowable that the rubber raw material can even be an isoprene rubber (i.e., synthetic natural rubber); but it can desirably be a natural rubber, one of natural resources.

Moreover, a characteristic of a manufacturing method according to the present invention for manufacturing the aforementioned modified rubber lies in that it comprises:

an epoxy-group introduction step of converting double bonds, which are included in respective isoprene units of a rubber raw material in which polyisoprene makes a major component, into epoxy groups, thereby making an epoxidized rubber raw material; and

a hydroxyl-group introduction step of hydrolyzing the epoxy groups, which are included in the epoxidized rubber raw material, and then converting them into hydroxyl groups.

It is desirable that all of the epoxy groups, which are included in the epoxidized rubber raw material, can be converted into hydroxyl groups and furan rings in the hydroxyl-group introduction step.

It is desirable that, when natural rubber is used as the rubber raw material, a deproteinization step of removing proteins in the natural rubber can be carried out before the epoxy-group introduction step.

It is desirable that the epoxy-group introduction step, and the hydroxyl-group introduction step can be carried out in the presence of an organic peracid; and they can be carried out in the presence of a co-solvent that is of high affinity to a latex of the rubber raw material and said epoxidized rubber raw material, and to the organic peracid.

### EFFECT OF THE INVENTION

The modified rubber according to the present invention is prepared from a rubber raw material in which polyisoprene makes a major component, and is completed by converting at least a part of double bonds that are included in respective isoprene units into hydroxyl groups. Because of this setting, the modified rubber according to the present invention is good in terms of gas non-permeability, and accordingly can be utilized as a substitute for ethylene-vinyl alcohol copolymers, and the like.

Moreover, in accordance with the manufacturing method according to the present invention, it is possible to introduce hydroxyl groups securely in the hydroxyl-group introduction step by first converting double bonds, which are included in a quantity of one in each of isoprene units, into epoxy groups. Therefore, it is possible to produce the modified rubber according to the present invention securely.

Although it is allowable that double bonds, which are not converted into epoxy groups, can remain in the epoxy-group introduction step, it is desirable to convert all of the double bonds into epoxy groups in order to introduce hydroxyl groups greatly. In order to perform like this, it is possible to achieve that by carrying out the epoxy-group introduction step and hydroxyl-group introduction step in the presence of an organic peracid, and in the presence of a co-solvent that is of high affinity to a latex of the rubber raw material and epoxidized rubber raw material, and to the organic peracid.

Moreover, although there might be cases where epoxy groups remain in the hydroxyl-group introduction step, it is desirable that all of the epoxy groups can be converted into hydroxyl groups and furan rings, and it is especially desirable that all of the epoxy groups can be converted into hydroxyl groups. That is, it is desirable that all of the double bonds that are included in the rubber raw material can be converted into hydroxyl groups, because the more the hydroxide groups are present in one molecule the more the gas non-permeability upgrades.

In addition, when natural rubber is used as the rubber raw material, it is desirable that a deproteinization step to remove proteins in natural rubber can be carried out before the epoxy-group introduction step. By doing thusly, it is believed that reactions in the epoxy-group introduction step and reactions in the hydroxyl-group introduction step can progress smoothly; and consequently it is possible to produce modified rubbers that have many hydroxyl groups.

### BRIEF DESCRIPTION OF THE DRAWINGS

FIG. 1 is a structural formula of a modified rubber that is directed to an example of the present invention;

FIG. 2 is an NMR spectrum of a modified rubber that was produced in an example according to the present invention;

FIG. 3 is an NMR spectrum of a modified rubber that was produced in another example according to the present invention; and

FIG. 4 is an explanatory diagram for illustrating a measurement method of gas permeability coefficient.

### EXPLANATION ON REFERENCE NUMERALS

1, and 3: Containers
2: Film Sample

### BEST MODE FOR CARRYING OUT THE INVENTION

A modified rubber according to the present invention is prepared from a rubber raw material in which polyisoprene makes a major component, and is completed by converting at least a part of double bonds that are included in respective isoprene units into hydroxyl groups. As for the rubber raw material in which polyisoprene makes a major component, although it is possible to use polyisoprene (i.e., synthetic natural rubber), it is desirable to use a natural rubber, one of natural resources. Note that, depending on cases, it is feasible as well to use rubber raw materials in which various monomers or polymers are grafted to a part of the double bonds of polyisoprene.

As far as at least apart of the double bonds that are included in the isoprene units are converted into hydroxyl groups, gas non-permeability is demonstrated by the presence of those hydroxyl groups. However, since the greater the number of the resulting hydroxyl groups is the more the gas non-permeability is enhanced, it is desirable that the double bonds that are included in the respective isoprene units can be converted into hydroxyl groups as many as possible; and it is most desirable that all of the double bonds that are included in the individual isoprene units can be converted into hydroxyl groups.

Note that, although it is possible to produce the modified rubber according to the present invention by means of a manufacturing method according to the present invention, the double bonds that are included in the respective isoprene units are first converted into epoxy groups and are thereafter converted into hydroxyl groups. Therefore, there might also be cases where the double bonds or the resulting epoxy groups remain therein, and accordingly modified rubbers that include double bonds or epoxy groups are also involved in the present invention. Moreover, since there might also be cases where furan rings are formed upon converting the resultant epoxy groups into hydroxyl groups, modified resins that include furan rings are involved as well in the present invention. Naturally, it is especially desirable that it can be modified rubbers with such a form in which no double bonds, epoxy groups and furan rings exist but only hydroxyl groups exist.

In a manufacturing method according to the present invention which makes the modified rubber according to the present invention obtainable, double bonds, which are included in respective isoprene units of a rubber raw material in which polyisoprene makes a major component, are first converted into epoxy groups, thereby making an epoxidized rubber raw material at an epoxy-group introduction step; and the resulting epoxy groups, which are included in the resultant epoxidized rubber raw material, are subsequently hydrolyzed, and are then converted into hydroxyl groups at a hydroxyl-group introduction step.

As for the rubber raw material in which polyisoprene makes a major component, it is desirable to use a natural rubber, one of natural resources, though it is possible to use polyisoprene (i.e., synthetic natural rubber) therefor, as described above.

When natural rubber is used, it is desirable to carry out a deproteinization step to remove proteins that are included in the natural rubber prior to the epoxy-group introduction step. By doing thusly, it is believed that reactions in the epoxy-group introduction step and reactions in the hydroxyl-group introduction step can progress smoothly; and consequently it is possible to produce modified rubbers that have many hydroxyl groups.

As for the deproteinization step, the following have been known: a method in which proteins are decomposed by adding proteolytic enzymes or bacteria to natural rubber latexes; a method in which latexes are washed repeatedly with surfactants, such as soaps; or a method in which proteins are denatured by means of urea; and the like.

For the natural rubber latexes, it is possible to employ any one of commercially-available ammoniated latexes or field latexes. As for said proteolytic enzymes, they are not limited in particular; although it is possible to use any one of those which stem from germs, those which stem from mold fungi or those which stem from yeasts, it is preferable to use proteases which stem from germs.

In order to decompose proteins in a latex with a proteolytic enzyme, it is allowable to add the proteolytic enzyme to the latex in an amount of about 0.001-10% by mass, stir them or place them at rest, and then process them for a few minutes-one week approximately. The processing temperature can be set to 5-90° C., and can preferably be 20-60° C.

Moreover, as for the surfactants, it is preferable to use an anionic surfactant, and a nonionic surfactant. As for the method of washing a latex with a surfactant repeatedly, it is possible to exemplify a method in which a surfactant is added to a latex in an amount of about 0.001-10% by mass and then wash it by means of centrifugal separation multiple times. Depending on cases, it is also possible to use a washing method in which latex particles are agglomerated by means of an agglomerating agent and are then separated.

The epoxy-group introduction step is a step of converting double bonds, which are included in respective isoprene units of a rubber raw material in which polyisoprene makes a major component, into epoxy groups. This epoxy-group introduction step can desirably be carried out using an organic peracid. By doing thusly, it is possible to advance the epoxy-group introducing reaction and hydroxyl-group introducing reaction in succession virtually simultaneously.

As for the organic peracid, perbenzoic acid, peracetic acid, performic acid, perphthalic acid, perpropionic acid, trifluoro peracetic acid, perbutyric acid, and the like, are exemplified, for instance. It is also allowable to add an organic peracid that is selected from these to a latex directly; or it is even permissible to add multiple species of chemical agents, which form an organic peracid, to a latex and then generate the organic peracid.

It is desirable that an addition amount of the organic peracid can be added excessively more than an equivalent that makes epoxy groups introducible into all of double bonds in a latex of the synthetic natural rubber or deproteinized natural rubber. Moreover, in the case where multiple species of chemical agents that form an organic peracid, an amount of the generating organic peracid is set to fall in this range. And, the double bonds that are included in the respective isoprene units are converted into epoxy groups by stirring them, or by placing them at rest.

And, in accordance with the method of introducing epoxy groups using an organic peracid, an organic acid is derived from the organic peracid, and then the hydrolysis reaction of the epoxy groups proceeds simultaneously in an acidic atmosphere resulting from it. Therefore, the double bonds that are included in the respective isoprene units are converted into hydroxyl groups, and thereby it is possible to produce the modified rubber according to the present invention.

However, since it is difficult to hydrolyze all of the generating epoxy groups by just mixing the organic peracid with the latex, and accordingly there might be cases where the epoxy groups remain in the obtained modified rubber. If the epoxy groups have remained, hydroxyl groups decrease by that extent so that the gas non-permeability declines.

Hence, the epoxy-group introduction step and hydroxyl-group introduction step can desirably be carried out in the presence of an organic peracid, and simultaneously they can desirably be carried out in the presence of a co-solvent that is of high affinity to both of a latex and the organic peracid. By reacting them in the presence of the co-solvent, it is possible to convert all of the resulting epoxy groups into hydroxyl groups.

As for the co-solvent, the following are exemplified: isopropyl alcohol, tetrahydrofuran, acetone, diethylene glycol dimethyl ether, t-butanol, and the like. Although its action mechanism has not been clear yet, it is conjectured that it facilitates the reactions in the epoxy-group introduction step and hydroxyl-group introduction step by dissolving water and the organic peracid therein, and by swelling rubber particles of the latex.

Although an addition amount of the co-solvent depends on the solvent species, it is preferable to fall in a range of 0.1-1,000 parts by mass with respect to 100 parts by mass of the latex's solid content. Since no advantageous effect of the adding is obtained and the resulting epoxy groups have come to remain when the addition amount of the co-solvent is less than this range, and since not only the advantageous effect saturates but also there might arise such cases that necessary reactions have been hindered when the addition amount of the co-solvent is more than this range, these settings are not preferable.

Note that there might be cases where furan rings as well as hydroxyl groups generate in the aforementioned reactions by means of the organic peracid. Although it is difficult at present to inhibit the generation of furan rings even when using the co-solvent, it is probable that an epoxidation rate can be controlled freely at the epoxy-group introduction step by studying the epoxidation reaction therein furthermore, and consequently it is highly probable that the resultant hydroxyl-group content ratio can be controlled at will.

### EXAMPLES

Hereinafter, the present invention will be explained in detail by means of examples and comparative examples.

### Example No. 1

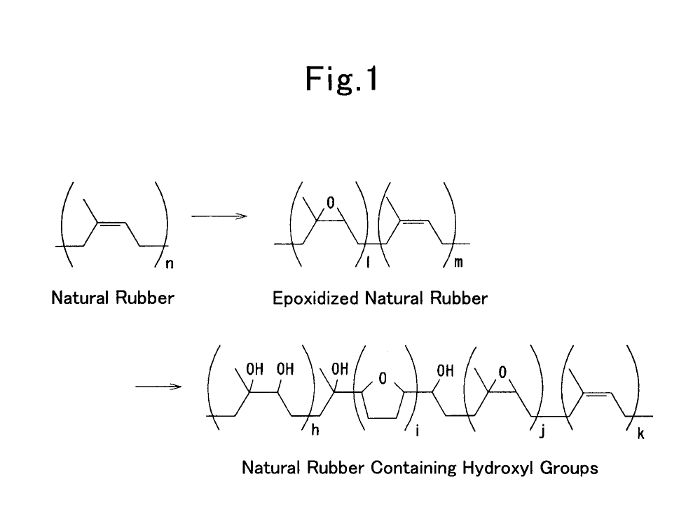

In FIG. 1, the structure of a modified rubber, which is directed to an example according to the present invention, is illustrated. This modified rubber is one which should be referred to as a hydroxyl-group-containing natural rubber, which is produced from a natural rubber via an epoxidized natural rubber, and in which all of the double bonds being included in the respective isoprene units are converted into hydroxyl groups, epoxy groups and furan rings. Hereinafter, a production process for this modified rubber will be explained to substitute for the detailed explanations on the constitution.

<Deprotenization Step>

With respect to 100 parts by mass of a commercially-available high-ammonia natural-rubber latex (solid content: 30% by mass), dodecyl sodium sulfate was added in an amount of 1.0 part by mass, and urea was added in an amount of 0.1 part by mass; and these were then placed at rest at room temperature for 1 hour after stirring them fully to dissolve therein. Note that the urea was added for the purpose of denaturing proteins.

The resulting mixture was subjected to centrifugal separation to remove the clear supernatant liquid, and the obtained creamy content was then mixed with a dodecyl sodium sulfate aqueous solution with 1%-by-mass concentration so as to make the solid content 30% by mass. And, it was subjected to centrifugal separation again, and was washed after repeating this step twice, thereby preparing a deprotenized natural-rubber latex.

<Epoxy-Group Introduction Step and Hydroxyl-Group Introduction Step>

With respect to 10 parts by mass of the solid content of the obtained deprotenized natural-rubber latex, peracetic acid was added in an amount of 70 parts by mass; and then they were mixed by stirring and were placed at rest at room temperature for 16 hours. Thereafter, ammonia water was added to the mixture to neutralize it; and then washing by means of centrifugal separation using distilled water was repeated several times. And, the solid content was dried under vacuum, thereby preparing a modified rubber.

<Composition Analysis>

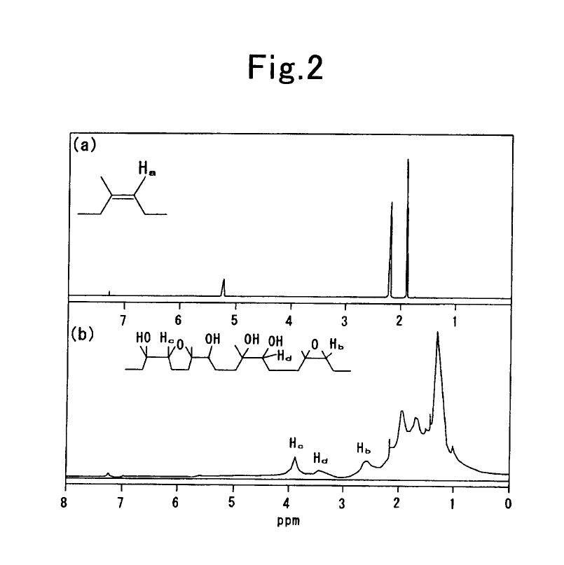

The deprotenized natural rubber being obtained in the deprotenization step, and the modified rubber being prepared were analyzed by NMR, and their spectra are shown in FIG. 2a and FIG. 2b, respectively.

It is recognized that, although a 5.2-ppm signal, which stems from the double bonds of the isoprene units, exists in the deprotenized natural rubber, that signal is not appreciated in the modified rubber so that the double bond had disappeared. That is, it is apparent that all of the double bonds have reacted by carrying out the epoxy-group introduction step and hydroxyl-group introduction step.

Moreover, since a signal, which stems from epoxy groups, appear at 2.7 ppm in the spectrum of the modified rubber; another signal, which stems from hydroxyl groups, appear at 3.4 ppm therein; and still another signal, which stems from furan rings, appear at 3.9 ppm therein; respectively, it is understood that the epoxy groups, hydroxyl groups, and furan rings were present, respectively. On the contrary, since these signals are not appreciated in the spectrum of the deprotenized natural rubber, it is apparent that these groups are generated in the epoxy-group introduction step and hydroxyl-group introduction step.

### Example No. 2

With respect to 10 parts by mass of the solid content of a deprotenized natural-rubber latex that was formed in the same manner as Example No. 1, not only peracetic acid was added in an amount of 70 parts by mass but also isopropyl alcohol (IPA) was added in an amount of 5 parts by mass; and then they were mixed by stirring and were placed at rest at room temperature for 16 hours. Thereafter, ammonia water was added to the mixture to neutralize it; and then washing by means of centrifugal separation using distilled water was repeated several times. And, the solid content was dried under vacuum, thereby preparing a modified rubber.

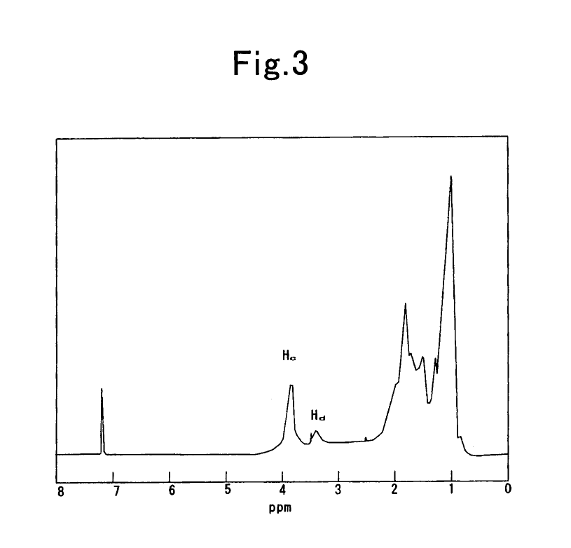

An NMR spectrum of the modified rubber being obtained are shown in FIG. 3. From FIG. 3, it is understood that not only a 5.2-ppm signal, which stems from the double bonds of the isoprene units, disappears but also a 2.7-ppm signal, which derives from epoxy groups, has disappeared, and consequently it is apparent that all of the double bonds were converted into hydroxyl groups or furan rings by adding isopropyl alcohol as a co-solvent.

### Example No. 3

### Deprotenization Step

A deprotenized natural-rubber latex was prepared in the same manner as Example No. 1 using a commercially-available high-ammonia natural-rubber latex (solid content: 30% by mass).

<Epoxy-Group Introduction Step and Hydroxyl-Group Introduction Step>

With respect to 20 g of the obtained deprotenized natural-rubber latex, peracetic acid was added in an amount of 14 g; and then they were mixed by stirring and were placed at rest at room temperature for 16 hours. Thereafter, ammonia water was added to the mixture to neutralize it; and then washing by means of centrifugal separation using distilled water was repeated several times. And, the solid content was dried under vacuum, thereby preparing a modified rubber.

### Example No. 4

### Deprotenization Step

A deprotenized natural-rubber latex was prepared in the same manner as Example No. 1 using a commercially-available high-ammonia natural-rubber latex (solid content: 30% by mass).

<Epoxy-Group Introduction Step and Hydroxyl-Group Introduction Step>

Except that, in addition to adding peracetic acid in an amount of 14 g to 20 g of the obtained deprotenized natural-rubber latex, isopropyl alcohol (IPA) serving as a co-solvent was further added in an amount of 2 mL thereto, a modified rubber was prepared in the same manner as Example No. 3.

### Example No. 5

### Deprotenization Step

A deprotenized natural-rubber latex was prepared in the same manner as Example No. 1 using a commercially-available high-ammonia natural-rubber latex (solid content: 30% by mass).

<Epoxy-Group Introduction Step and Hydroxyl-Group Introduction Step>

Except that, in addition to adding peracetic acid in an amount of 14 g to 40 g of the obtained deprotenized natural-rubber latex, isopropyl alcohol (IPA) serving as a co-solvent was further added in an amount of 20 mL thereto, a modified rubber was prepared in the same manner as Example No. 3.

### Example No. 6

### Deprotenization Step

A deprotenized natural-rubber latex was prepared in the same manner as Example No. 1 using a commercially-available high-ammonia natural-rubber latex (solid content: 30% by mass).

<Epoxy-Group Introduction Step and Hydroxyl-Group Introduction Step>

Except that, in addition to adding peracetic acid in an amount of 14 g to 20 g of the obtained deprotenized natural-rubber latex, diethylene glycol dimethyl ether (DEGDME) serving as a co-solvent was further added in an amount of 10 mL thereto, a modified rubber was prepared in the same manner as Example No. 3.

### Example No. 7

### Deprotenization Step

A deprotenized natural-rubber latex was prepared in the same manner as Example No. 1 using a commercially-available high-ammonia natural-rubber latex (solid content: 30% by mass).

<Epoxy-Group Introduction Step and Hydroxyl-Group Introduction Step>

Except that, in addition to adding peracetic acid in an amount of 14 g to 40 g of the obtained deprotenized natural-rubber latex, tetrahydrofuran (THF) serving as a co-solvent was further added in an amount of 10 mL thereto, a modified rubber was prepared in the same manner as Example No. 3.

<Composition Analysis>

The composition proportions of the epoxy groups, hydroxyl groups and furan rings were calculated respectively from the NMR spectra of the modified rubbers that were produced in the respective examples; the results are shown in Table 1, respectively.

TABLE 1

| | | | Content (%) | | |
|---|---|---|---|---|---|
| | Co-solvent | | Hydroxyl | Furan | Epoxy |
| | Type | Amount | Groups | Rings | Groups |
| Ex. No. 3 | — | — | 21 | 45 | 34 |
| Ex. No. 4 | IPA | 2 mL | 35 | 65 | 0 |
| Ex. No. 5 | IPA | 20 mL | 19 | 81 | 0 |
| Ex. No. 6 | DEGDME | 10 mL | 20 | 80 | 0 |
| Ex. No. 7 | THF | 10 mL | 29 | 71 | 0 |

From Table 1, any epoxy groups are not appreciated in the modified rubbers other than that of Example No. 3, and only hydroxyl groups and furan rings exist therein. That is, it is apparent that epoxy groups are vanished by using a co-solvent at the epoxy-group introduction step and hydroxyl-group introduction step.

### Comparative Example No. 1

A deprotenized natural-rubber latex being prepared in Example No. 1 was dried under vacuum, and was then labeled a modified rubber according to Comparative Example No. 1.

### Comparative Example No. 2

A commercially-available ethylene-vinyl alcohol copolymer (“EVAL-G156B” produced by KURARAY Co., Ltd.) was labeled a modified rubber according to Comparative Example No. 2.

<Gas Permeability Test>

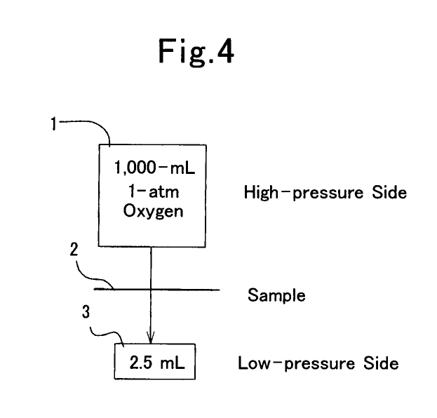

Film samples were made from the modified rubbers according to Example No. 2, Comparative Example No. 1 and Comparative Example No. 2, respectively, and their gas permeability coefficients were measured by a differential pressure method. “BT-3” produced by TOYO SEIKI SEISAKUSHO, Ltd. was used for the measurement; a 2.5-mL container 3 was put in place so as to serve as a low-pressure side with respect to a 1,000-mL container 1 in which 1-atm oxygen was filled while interposing a film sample 2 between the two, as illustrated in FIG. 4; and then pressure changes within the container 3 on the low-pressure side were measured. Note that the unit of the gas permeability coefficient specifies a volume of oxygen (cm³) that permeates through a 1-μm film at 1 atm over 1 m² for 1 day.

Regarding Comparative Example No. 1, the measurement was completed for 2 hours because a steady state was attained for about 15 minutes approximately after starting the measurement. Regarding Comparative Example No. 2, the measurement was completed for 62 hours because a steady state was attained roughly for 58 hours after starting the measurement. Moreover, regarding Example No. 2, since the film samples were so brittle that it was difficult to subject them to the measurement independently, two pieces of the film samples according to Comparative Example No. 1 were used; a film according to Example No. 2 was held between them like a sandwich; and then the measurement was done. The measurement was completed for 21 hours because a steady state was attained roughly for 18 hours after starting the measurement. The measurements were carried out twice, respectively, and the resultant average values are shown in Table 2.

TABLE 2

Gas Permeability Coefficient
(cm³ · μm/m² · day · atm)

| | Actual | |
|---|---|---|
| | Measurement Value | Average Value |
| Example No. 2 | 4.36 × 10⁴ | 3.98 × 10⁴ |
| | 3.42 × 10⁴ | |
| Comparative | 1.59 × 10⁶ | 1.61 × 10⁶ |
| Example No. 1 | 1.62 × 10⁶ | |
| Comparative | 5.72 × 10² | 5.17 × 10² |
| Example No. 2 | 4.61 × 10² | |

From Table 2, although the gas permeability coefficient of the films that are directed to Example No. 2 were higher than that of Comparative Example No. 2, they exhibited a gas permeability coefficient that was lower by two digits or more, compared with that of the deprotenized natural rubber according to Comparative Example No. 1; consequently, it is apparent that the gas non-permeability is improved by means of the hydroxyl-group introduction.

Moreover, since the modified rubber that is directed to Example No. 2 has many furan rings as shown in FIG. 3, it is possible to introduce many more hydroxyl groups by controlling the reactions of the epoxy-group introduction step so as to introduce many more epoxy groups; therefore, it is expected that the gas non-permeability can be upgraded furthermore.

### INDUSTRIAL APPLICABILITY

It is possible to make use of the modified rubber according to the present invention to films for food packaging, inner liners of tires, or airtight containers, and the like, because it is good in terms of gas non-permeability.

1. A modified rubber wherein:
it is prepared from a rubber raw material in which polyisoprene makes a major component; and
it is completed by converting all of double bonds into hydroxyl groups and tetrahydrofuran rings.

2. (canceled)

3. The modified rubber as set forth in claim 1, wherein said rubber raw material is natural rubber.

4. A manufacturing method for modified rubber, comprising:
an epoxy-group introduction step of converting double bonds, which are included in respective isoprene units of a rubber raw material in which polyisoprene makes a major component, into epoxy groups, thereby making an epoxidized rubber raw material; and
a hydroxyl-group introduction step of hydrolyzing the epoxy groups, which are included in the epoxidized rubber raw material, and then converting them into hydroxyl groups, wherein all of the epoxy groups, which are included in the epoxidized rubber raw material, are converted into hydroxyl groups and tetrahydrofuran rings in the hydroxyl-group introduction step.

5. (canceled)

6. The manufacturing method for modified rubber as set forth in claim 4, wherein:
said rubber raw material is natural rubber; and
a deproteinization step of removing proteins in the natural rubber is further carried out before the epoxy-group introduction step.

7. The manufacturing method for modified rubber as set forth in either one of claim 4, wherein:
said epoxy-group introduction step, and said hydroxyl-group introduction step are carried out in the presence of an organic peracid; and
they are carried out in the presence of a co-solvent that swells a latex of said rubber raw material and said epoxidized rubber raw material, and that dissolves water and the organic peracid.

8. A film for food packaging, comprising the modified rubber as set forth in claim 1.

9. The manufacturing method for modified rubber as set forth in claim 7, wherein said co-catalyst is at least one member that is selected from the group consisting of isopropyl alcohol, tetrahydrofuran, acetone, diethylene glycol dimethyl ether, and t-butanol.

10. The manufacturing method for modified rubber as set forth in claim 6, wherein:
said epoxy-group introduction step, and said hydroxyl-group introduction step are carried out in the presence of an organic peracid; and
they are carried out in the presence of a co-solvent that swells a latex of said rubber raw material and said epoxidized rubber raw material, and that dissolves water and the organic peracid.
